(19) United States
(12) Patent Application Publication
(10) Pub. No.: US 2014/0016507 A1
(43) Pub. Date: Jan. 16, 2014

(54) METHOD AND APPARATUS FOR HANDLING TOPOLOGY IN WIRELESS COMMUNICATION SYSTEM

(71) Applicant: Samsung Electronics Co., Ltd., Gyeonggi-do (KR)

(72) Inventors: Se-Hee Han, Seoul (KR); Mayuresh Madhukar Patil, Gyeonggi-do (KR); Ji-Hye Lee, Seoul (KR); Jun-Hyung Kim, Gyeonggi-do (KR); Jong-Hyo Lee, Gyeonggi-do (KR)

(73) Assignee: Samsung Electronics Co., Ltd.

(21) Appl. No.: 13/942,004

(22) Filed: Jul. 15, 2013

Related U.S. Application Data
(60) Provisional application No. 61/672,039, filed on Jul. 16, 2012.

(51) Int. Cl. H04W 28/18

(52) U.S. Cl. CPC H04W 28/18
USPC 370/254

(57) ABSTRACT

A topology handling method for supporting a first device to form a Peer to Peer (P2P) group with a second device in a wireless communication system is provided. The method includes sending, by the first device, an invitation request to the second device; and upon receiving a wait message from the second device in response to the invitation request, performing a negotiation procedure for forming the P2P group with the second device, based on status information included in the wait message. The status information is used to indicate whether the second device can use other services.

### PRIORITY

This application claims priority under 35 U.S.C. §119(a) to a United States Provisional Patent Application filed in the United States Patent and Trademark Office on Jul. 16, 2012 and assigned Ser. No. 61/672,039, the entire disclosure of which is incorporated herein by reference.

### BACKGROUND OF THE INVENTION

1. Field of the Invention

The present invention relates generally to a wireless communication system, and more particularly, to a method and apparatus for handling topology in a wireless communication system.

2. Description of the Related Art

Wi-Fi Direct is a technology for delivering data through direct connections between mobile devices. More specifically, Wi-Fi Direct refers to the technology applied to mobile devices, such as Televisions (TVs), laptop computers, printers and digital cameras, providing the infrastructure where users may enjoy inter-device content and service through direct communication between terminals without separate equipment such as an Access Point (AP) and a router. Wi-Fi Direct may be interchangeable with Wi-Fi Peer to Peer (P2P). Although there is Bluetooth which is widely used as direct wireless connection technology, Wi-Fi Direct, as compared to Bluetooth, is capable of inter-device connection and high-speed transmission of mass data. Unlike conventional Wi-Fi that is low in mobility as a mobile device newly scans and accesses an AP installed in its area after its move from one area to another area, Wi-Fi Direct may solve some of the low-mobility problems of the existing Wi-Fi, as it can maintain inter-device connections.

In a Wi-Fi P2P group, a device serves as an AP in the existing infrastructure network, and this device is called a Group Owner (GO). In one group, only one device may serve as a GO and the other devices are all client devices.

In Wi-Fi Direct, a sending device performs a device/service discovery step in a pre-association step in order to discover terminals/services that it desires to connect with. Once the sending device selects one of the discovered devices/services, the sending device sends a connection request to the selected device/service. In this case, errors may occur depending on the hardware or software constraints, operation status, and/or network topology of the selected device that has received the connection request. If errors occur, the sending device that has sent the connection request should periodically re-send the connection request until it is connected without error, causing a lot of signaling and unnecessary power consumption.

### SUMMARY OF THE INVENTION

The present invention has been made to address at least the above-mentioned problems and/or disadvantages and to provide at least the advantages described below. Accordingly, an aspect of embodiments of the present invention is to provide a topology handling method and apparatus for transmitting and receiving files in a wireless communication system.

Another aspect of embodiments of the present invention is to provide a topology handling method and apparatus for allowing a sending terminal to transmit and receive files in a wireless communication system.

Another aspect of embodiments of the present invention is to provide a topology handling method and apparatus for reducing errors when periodically transmitting files to a discovered counterpart terminal in a wireless communication system.

Another aspect of embodiments of the present invention is to provide a topology handling method and apparatus for forming a P2P group with another device that has already formed a group, in a wireless communication system.

In accordance with an aspect of the present invention, there is provided a topology handling method for supporting a first device to form a Peer to Peer (P2P) group with a second device in a wireless communication system. The method includes sending, by the first device, an invitation request to the second device; and upon receiving a wait message from the second device in response to the invitation request, performing a negotiation procedure for forming the P2P group with the second device, based on status information included in the wait message. The status information is used to indicate whether the second device can use other services.

In accordance with another aspect of the present invention, there is provided a topology handling method for supporting a first device to form a Peer to Peer (P2P) group with at least one second device in a wireless communication system. The method includes sending, by the first device, an open service request to all devices; and upon receiving a response message to the open service request from at least one second device among all the devices, performing a negotiation procedure for forming the P2P group with the at least one second device based on status information included in the response message. The status information is used to indicate whether the at least one second device can use other services.

In accordance with further another aspect of the present invention, there is provided a topology handling apparatus for supporting a first device to form a Peer to Peer (P2P) group with a second device in a wireless communication system. The apparatus includes a transmitting unit of the first device, which is configured to send an invitation request to the second device; and a controller of the first device, which is configured to, upon receiving a wait message from the second device in response to the invitation request, perform a negotiation procedure for forming the P2P group with the second device, based on status information included in the wait message. The status information is used to indicate whether the second device can use other services.

In accordance with yet another aspect of the present invention, there is provided a topology handling apparatus for supporting a first device to form a Peer to Peer (P2P) group with at least one second device in a wireless communication system. The apparatus includes a transmitting unit of the first device, which is configured to send an open service request to all devices; and a controller of the first device, which is configured to, upon receiving a response message to the open service request from at least one second device among all the devices, perform a negotiation procedure for forming the P2P group with the at least one second device based on status information included in the response message. The status information is used to indicate whether the at least one second device can use other services.

In accordance with still another aspect of the present invention, there is provided a topology handling method for supporting a second device to form a Peer to Peer (P2P) group with a first device in a wireless communication system. The method includes receiving, by the second device, an invitation request from the first device; sending, to the first device, a wait message including status information indicating whether the second device can use other services; and performing a negotiation procedure for forming the P2P group with the first device, based on the status information.

In accordance with still another aspect of the present invention, there is provided a topology handling method for supporting at least one second device to form a Peer to Peer (P2P) group with a first device in a wireless communication system. The method includes receiving, by the at least one second device, an open service request from the first device; sending to the first device a response message including status information indicating whether the at least one second device can use other services; and performing a negotiation procedure for forming the P2P group with the first device.

In accordance with still another aspect of the present invention, there is provided a topology handling apparatus for supporting a second device to form a Peer to Peer (P2P) group with a first device in a wireless communication system. The apparatus includes a receiving unit of the second device, which is configured to receive an invitation request from the first device; a transmitting unit of the second device, which is configured to send, to the first device, a wait message including status information indicating whether the second device can use other services; and a controller of the second device, which is configured to perform a negotiation procedure for forming the P2P group with the first device, based on the status information.

In accordance with still another aspect of the present invention, there is provided a topology handling apparatus for supporting at least one second device to form a Peer to Peer (P2P) group with a first device in a wireless communication system. The apparatus includes a receiving unit of the at least one second device, which is configured to receive an open service request from the first device; a transmitting unit of the at least one second device, which is configured to send to the first device a response message including status information indicating whether the at least one second device can use other services; and a controller of the at least one second device, which is configured to perform a negotiation procedure for forming the P2P group with the first device.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates an example of the system architecture, to which Wi-Fi Direct connection is applicable, according to an embodiment of the present invention;

FIG. 2 is a flow diagram illustrating a topology handling method in a wireless communication system according to a first embodiment of the present invention;

FIG. 3 is a flow diagram illustrating an example of a topology handling method in a wireless communication system according to a second embodiment of the present invention;

FIG. 4 is a flow diagram illustrating another example of a topology handling method in a wireless communication system according to the second embodiment of the present invention;

FIG. 5 is a flow diagram illustrating a topology handling method in a wireless communication system according to a third embodiment of the present invention;

FIGS. 6 and 7 illustrate different examples in which a sender may form a P2P group with a specific receiver when there are multiple receivers;

FIG. 8 is a flowchart illustrating a topology handling method by a sender in a wireless communication system according to an embodiment of the present invention;

FIG. 9 is a flowchart illustrating a topology handling method by a receiver in a wireless communication system according to an embodiment of the present invention;

FIGS. 10 and 11 are topology flow diagrams for a sender and a receiver according to an embodiment of the present invention; and

FIG. 12 is a block diagram illustrating structures of a sender and a receiver according to an embodiment of the present invention.

Throughout the drawings, like reference numerals will be understood to refer to like parts, components, and structures.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but are merely used to enable a clear and consistent understanding of the invention. Accordingly, it should be apparent to those skilled in the art that the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. The term “topology” as used herein may refer to the arrangement and relationships of connections between multiple devices. Particularly, in Wi-Fi Direct, the term “topology” may refer to Group Owners (GOs) or group members in the same group. Therefore, topology devices may communicate with each other directly, using an Internet Protocol (IP), or through a GO.

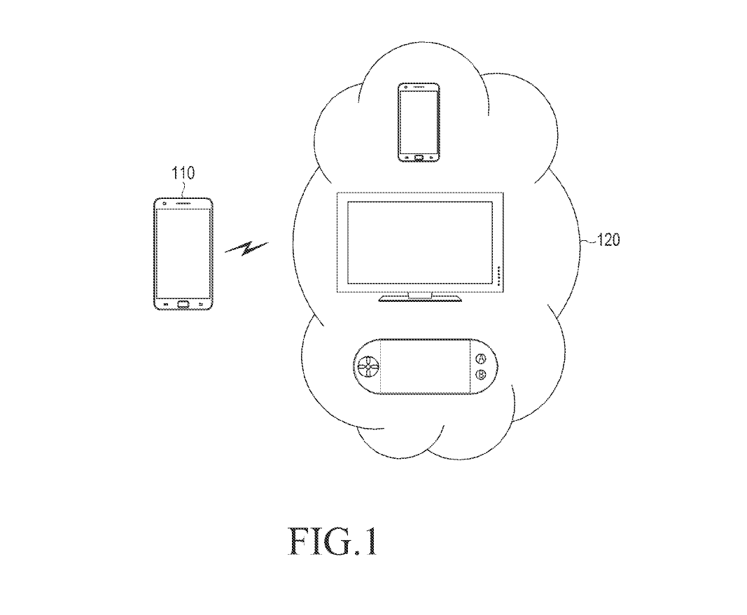

FIG. 1 illustrates an example of the system architecture, to which Wi-Fi Direct connection is applicable, according to an embodiment of the present invention.

Referring to FIG. 1, a sending terminal 110 is a Wi-Fi terminal that can serve as a sender and a service seeker, and a receiving terminal 120 is a Wi-Fi terminal that can serve as a receiver and a service advertiser. The terms ‘sending terminal’ and ‘receiving terminal’ are used herein for convenience only. The receiving terminal 120 may be one or multiple Wi-Fi terminals. For example, the sending terminal 110 and the receiving terminal 120, which are electronic devices with a Wi-Fi module embedded therein, may be a variety of electronic devices, such as mobile communication terminals, smart phones, Portable Multimedia Players (PMPs), digital broadcasting players, Personal Digital Assistants (PDAs), music players, display devices, mobile game consoles, printers and digital cameras, all of which operate based on at least one of the communication protocols corresponding to a variety of communication systems. The sending and receiving terminals 110 and 120 may be included and operated in large and medium-sized terminals such as Televisions (TVs), Large Format Displays (LFDs), Digital Signages (DSs), media poles, Personal Computers (PCs), laptop computers, printers and multifunction printers.

A Wi-Fi based system may support a Wi-Fi Direct function between the sending terminal 110 and the receiving terminal 120, and establish a Wi-Fi connection between them using Direct Access (DA) mode. In other words, FIG. 1 illustrates the architecture in which a connection is set up between the Wi-Fi terminals 110 and 120 by a Wi-Fi Direct scheme. In this system, the Wi-Fi terminals 110 and 120, which are located close to each other, may directly establish a Wi-Fi connection between them using a Wi-Fi module embedded (or connected as a peripheral device) therein, without an Access Point (AP).

The Wi-Fi terminals 110 and 120 may exchange with each other the support information for their own supportable functions. For example, if a user runs a Wi-Fi service-based application in the sending terminal 110, the sending terminal 110 identifies the support information transmitted by the receiving terminal 120. Based on the support information, the sending terminal 110 may primarily select a receiving terminal(s) whose manufacturer is the same as that of, for example, the sending terminal 110, depending on predetermined selection conditions. If a plurality of receiving terminals are primarily selected, a receiving terminal(s), which may support a Wi-Fi service for the application running in the sending terminal 110, may be secondarily selected from the selected receiving terminals. If a plurality of receiving terminals are secondarily selected, an optimal receiving terminal for the Wi-Fi service may be determined depending on the signal quality information (for example, Received Signal Strength Information (RSSI) and the like) of the selected receiving terminals. The sending terminal 110 may deliver information about the running application to the finally determined receiving terminal 120, to instruct the receiving terminal 120 to run an application associated with the information.

Although the Wi-Fi terminals 110 and 120 are assumed to be connected to each other by the Wi-Fi Direct scheme in the system architecture illustrated in FIG. 1, it will be apparent to those of ordinary skill in the art that the embodiments of the present invention are not necessarily applied when the Wi-Fi terminals 110 and 120 are connected to each other only by Wi-Fi Direct. In other words, the embodiments of the present invention may be applied even when the Wi-Fi terminals 110 and 120 use Wireless Local Area Network (WLAN), and are connected to each other via an AP.

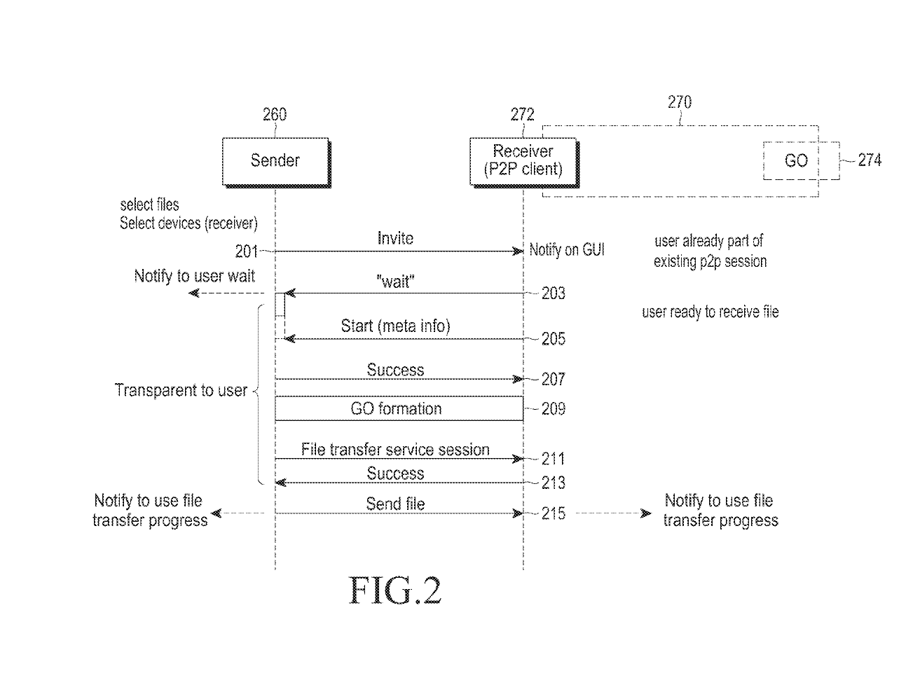

FIG. 2 is a flow diagram illustrating a topology handling method in a wireless communication system according to a first embodiment of the present invention. In the first embodiment of the present invention, a receiver is a P2P client and a sender desires to share files with one receiver. It is assumed that a receiver 272 and a GO 274 belong to the same group 270, and are connected to each other. In other words, it is assumed that the receiver 272 and the GO 274 have formed an existing P2P group, and a sender 260 desires to connect with the receiver 272. Reference to a “user” as provided at the side of the sender 260 in FIG. 2 means a user of the sender 260, while reference to a “user” as provided at the side of the receiver 272 and the GO 274 means a device.

The sender 260 (sending terminal 110) sends an invite message to the receiver 272 (receiving terminal 120) in step 201. It is assumed that the receiver 272 is a P2P client, has a P2P session, and is ready to receive files. Before sending the invite message in step 201, the sender 260 selects a file to transmit, and selects at least one device through a scan process. Although not illustrated in FIG. 2, before sending the invite message in step 201, the sender 260 may send a provision discovery request message to the receiver 272, and the receiver 272 may send a response message to the provision discovery request message to the sender 260 (Discovery Process). In the discovery process, the sender 260 determines a receiver to which it desires to transmit files.

After step 201, the receiver 272 sends a wait message to the sender 260 in step 203. Not only this wait message, but also a below-described wait message, include service status information (hereinafter, “status information”) used to indicate whether the receiver 272 can use other services. In other words, connection capability of the receiver 272 is reflected in the status information. For example, if the receiver 272 can use other services, the status information is set to “Available”. On the other hand, if the receiver 272 cannot use other services, the status information is set to “Unavailable”.

Upon receiving the wait message, the sender 260 notifies its user. After a predetermined lapse of time, the receiver 272 sends a start message including metadata to the sender 260 in step 205. The metadata includes confirm information for a target desiring to receive the file.

Based on the status information transmitted by the receiver 272, the sender 260 determines whether the receiver 272 supports a specific service such as file transfer, and sends a success message to the receiver 272 in step 207.

In step 209, the sender 260 performs group formation to form a group 270 for the receiver 272. Although not illustrated in FIG. 2, the sender 260 performs authentication on a terminal in the group 270, and sets up a connection to the receiver 272 through association.

The sender 260 sets up a file transfer service session to the receiver 272 in steps 211 and 213, and transmits the file through the file transfer service session in step 215.

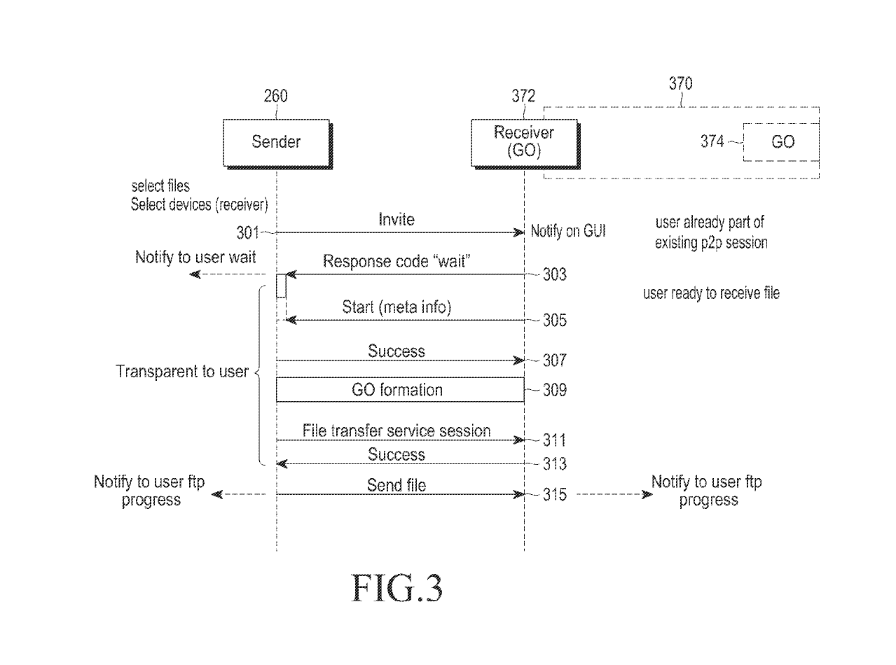

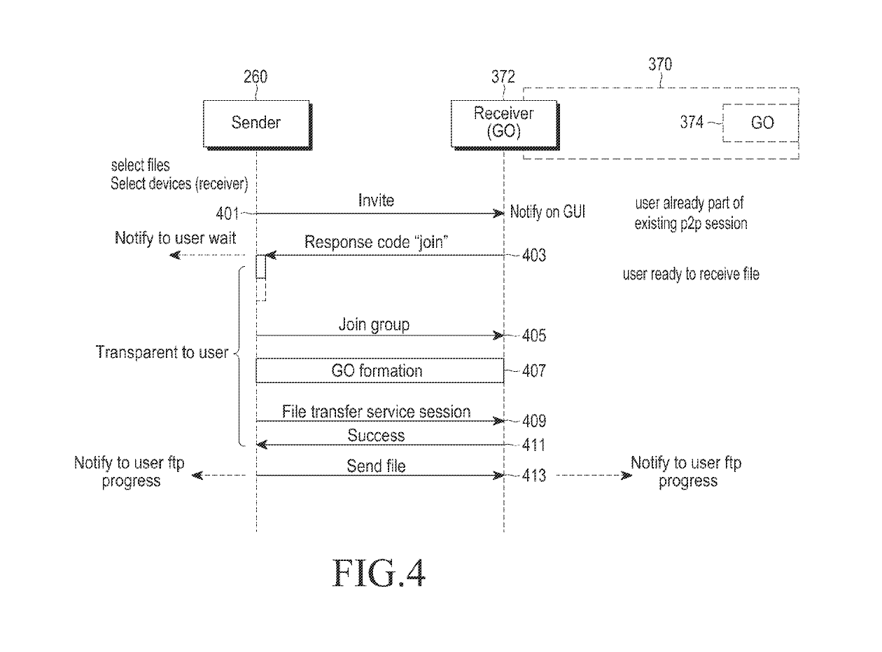

FIG. 3 is a flow diagram illustrating an example of a topology handling method in a wireless communication system according to a second embodiment of the present invention. In the second embodiment of the present invention, a receiver is a GO and a sender desires to send files to a specific peer device. The peer device may be a P2P client in an existing group. It is assumed that a receiver 372 and a GO 374 belong to the same group 370, and are connected to each other. In other words, it is assumed that the receiver 372 and the GO 374 have formed an existing P2P group, and the sender 260 desires to connect with the receiver 372. Reference to a “user” as provided at the side of the sender 260 in FIGS. 3 and 4 means a user of the sender 260, while reference to a “user” as provided at the side of the receiver 372 and the GO 374 means a device.

The sender 260 (sending terminal 110) sends an invite message to the receiver 372 (receiving terminal 120) in step 301. It is assumed that the receiver 372 is a GO, has a P2P session, and is ready to receive files. Steps 301 to 315 in FIG. 3 are the same as steps 201 to 215 in FIG. 2 in terms of operation except for the target receiver, so a detailed description thereof will be omitted.

FIG. 4 is a flow diagram illustrating another example of a topology handling method in a wireless communication system according to the second embodiment of the present invention. It is assumed that the receiver 372 and the GO 374 belong to the same group 370, and are connected to each other.

Referring back to FIG. 3, the receiver 372 sends a wait message to the sender 260 in step 303, and then sends a start message including metadata to the sender 260 in step 305. The metadata includes confirm information for a target desiring to receive the file. On the other hand, in FIG. 4, the receiver 372 sends a join message to the sender 260 in step 403, and then the sender 260 sends a join group message to the receiver 372 in step 405. The rest of the process is the same as that in FIG. 3. In other words, in FIGS. 2 and 3, the receivers 272 and 372, which have already formed a group, form a new group with the sender 260 after releasing the existing groups 270 and 370. However, in FIG. 4, the receiver 372 and the GO 374, which have already formed a group, allow the sender 260 to join the existing group 370 without releasing the existing group 370.

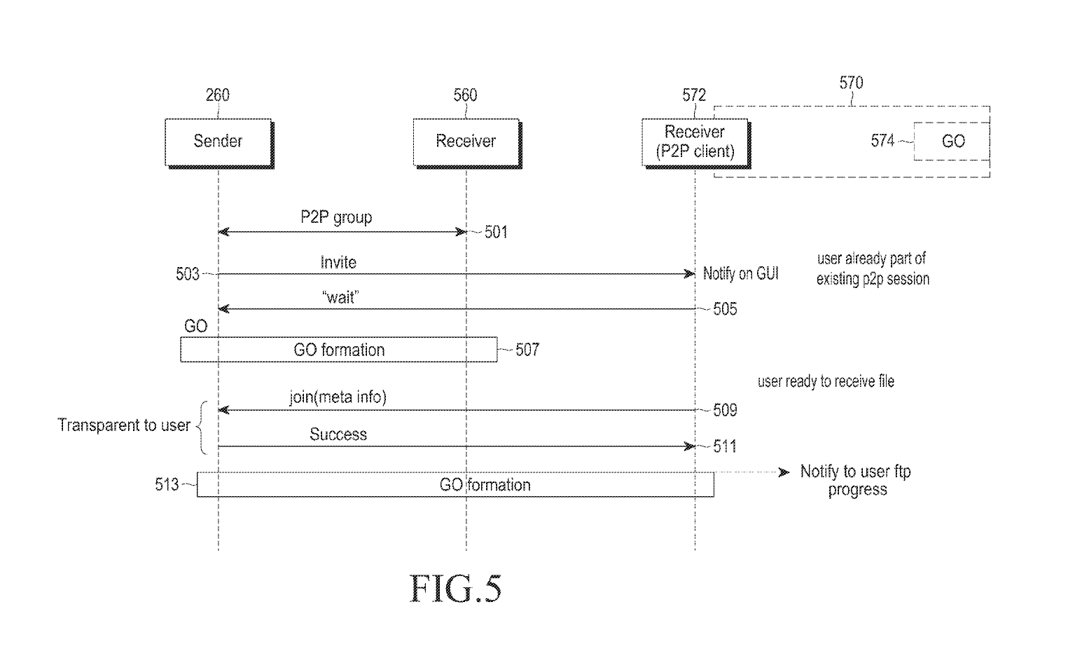

FIG. 5 is a flow diagram illustrating a topology handling method in a wireless communication system according to a third embodiment of the present invention.

In the third embodiment of the present invention, it is assumed that there is a plurality of receivers and a certain receiver belongs to (or has joined) a group. In addition, it is assumed that a peer device may support a concurrent mode-P2P session.

A sender 260 forms a P2P group with a receiver 560 in step 501, and sends an invite message to a receiver 572 in step 503. In this case, the receiver 572 is a P2P client. After step 503, the receiver 572 sends a wait message to the sender 260 in step 505.

Upon receiving the wait message, the sender 260 performs group formation on the receiver 560 in step 507. In step 509, the receiver 572 sends a join message including metadata to the sender 260. The metadata includes confirm information for a target desiring to receive the file. In step 511, the sender 260 sends a success message to the receiver 572 to notify the receiver 572 that it has successfully received the join message. Thereafter, the sender 260 and the receiver 572 form a group in step 513.

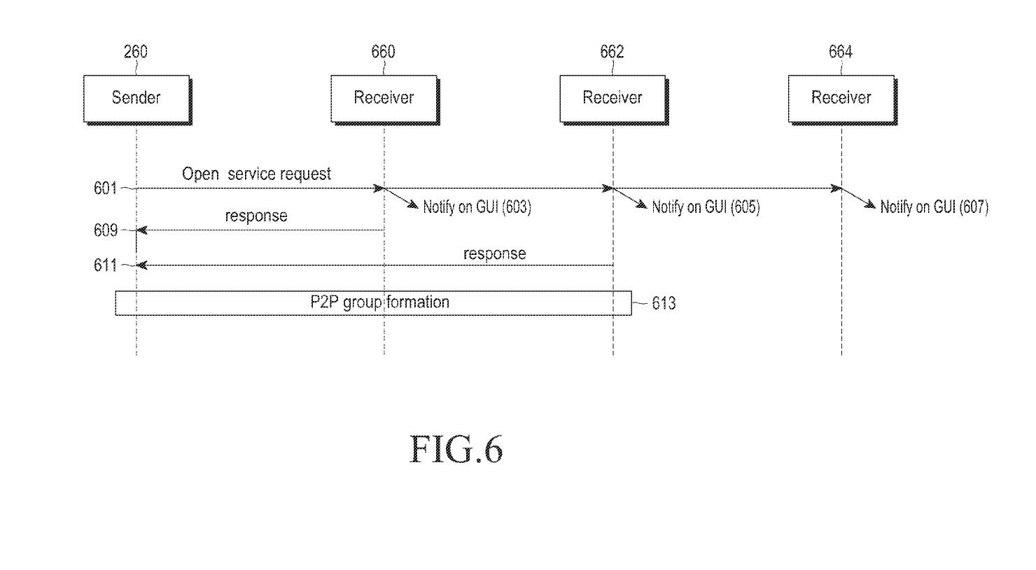

FIG. 6 illustrates an example in which a sender may form a P2P group with a specific receiver when there are multiple receivers. To this end, a sender sends an open service request message to each receiver. Among the receivers, only an interested receiver joins a P2P group session, and sends a response message to the open service request message to the sender.

A user of the sender 260 sends an open service request to all users in step 601. Among all the users, another interested arbitrary user may desire to join another P2P group, so there is a need for the open service request. The term ‘open service request’ as used herein refers to a service request for which a requestee is not specified. In other words, the open service request refers to a service request that a device sends to any devices which may be its own clients by forming a P2P group with the device itself in the future. An example of the open service request may include an open invitation request. Referring to FIG. 6, sender 260 sends an open service request message to a plurality of receivers 660, 662, and 664. Among the plurality of receivers, receivers 660, 662, which are interested in the service that the sender 260 will deliver, send a response message in steps 609 and 611 to the open service request message to the sender 260. The response message to the open service request message includes the above-described status information.

In response, the sender discovers any device interested in the service to be delivered by the sender among the plurality of receivers, and selects the discovered device. Thereafter, the sender forms a P2P group with the selected devices (or receivers) 660 and 662.

Upon receiving an open service request message from the sender, a receiver determines whether it is interested in the service delivered by the sender, and reflects the determination results in the status information. A response message to the open service request message includes the status information. In other words, connection capability of the receiver is reflected in the status information. For example, if the receivers 660 and 662 can use other services, the status information is set to “Available”. On the other hand, if the receiver 664 cannot use other services, the status information is set to “Unavailable”.

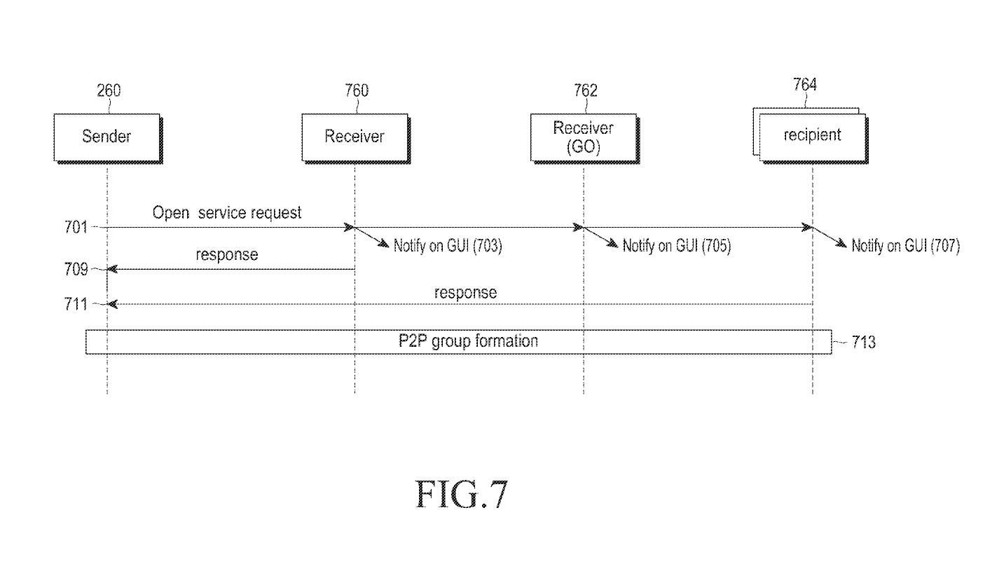

FIG. 7 illustrates another example in which a sender 260 may form a P2P group with a specific receiver when there are multiple receivers. Particularly, in the case of FIG. 7, the specific receiver 762 is a GO. To this end, the sender 260 sends an open service request message to each receiver 760, 762, and 764. In response, interested receivers 760 and 764 among the receivers join a P2P group session.

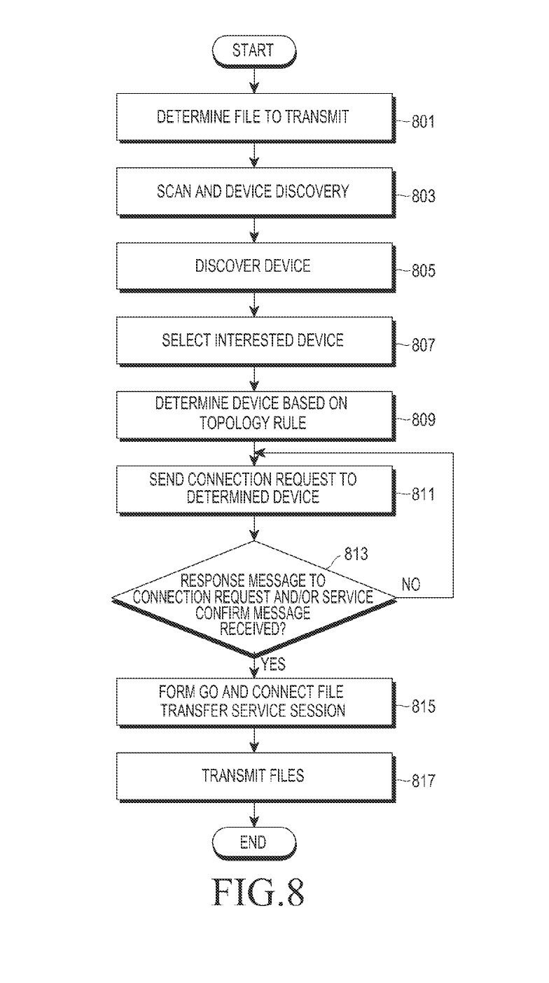

FIG. 8 is a flowchart illustrating a topology handling method by a sender in a wireless communication system according to an embodiment of the present invention.

In step 801, a sender determines at least one file to transmit. In step 803, the sender discovers a counterpart terminal (for example, a receiver) capable of Wi-Fi communication, through a scan and device discovery process. In step 805, based on the discovery results, the sender determines one or more devices to which it will send a file.

In step 807, the sender selects at least one device interested in Wi-Fi Direct among the determined devices. In step 809, the sender determines a device to which it will send the file, based on the topology rules (or connection capabilities). The topology rules are determined based on at least one of a planned policy, a current device status and a service type. The topology rules (or connection capabilities) are as shown in Table 1 below.

TABLE 1

| PD | PD Requester | | |
|---|---|---|---|
| Responder | New | Client | GO |
| New | GO Negotiation | Requestor will | Responder will join |
| | | autonomously start a | Requestor's group |
| | | P2P group by | |
| | | becoming a P2P GO | |
| Client | Requestor will | Fail | Responder will join |
| | autonomously start a | | Requestor's group |
| | P2P group by | | |
| | becoming a P2P GO | | |
| GO | Requestor will join | Requestor will join | Fail |
| | Responder's group | Responder's group | |

In Table 1, a Provision Discovery (PD) Requestor may refer to a sender, and a PD Responder may refer to a receiver.

Referring to Table 1, if the PD Requestor is “New” and the PD Responder is “New”, GO negotiation between the PD Requestor and the PD Responder is performed. If the PD Requestor is “Client” and the PD Responder is “New”, the PD Requestor will autonomously start a P2P group by becoming a P2P GO. If the PD Requestor is “GO” and the PD Responder is “New”, the PD Responder will join a group of the PD Requestor.

If the PD Requestor is “New” and the PD Responder is “Client”, the PD Requestor will autonomously start a P2P group by becoming a P2P GO. If the PD Requestor is “Client” and the PD Responder is “Client”, GO negotiation between the PD Requestor and the PD Responder has failed. If the PD Requestor is “GO” and the PD Responder is “Client”, the PD Responder will join a group of the PD Requestor.

If the PD Requestor is “New” and the PD Responder is “GO”, the PD Requestor will join a group of the PD Responder. If the PD Requestor is “Client” and the PD Responder is “GO”, the PD Requestor will join a group of the PD Responder. If the PD Requestor is “GO” and the PD Responder is “GO”, GO negotiation between the PD Requestor and the PD Responder has failed.

Step 809 is optional.

In step 811, the sender sends a connection request to the determined and/or selected device. The sender waits until it receives a response message to the connection request. The sender waits until it receives a service confirm message from receivers.

In step 813, the sender determines whether it has received a response message to the connection request and/or a service confirm message from the receiver. If it has not, the process returns to step 811. Upon receiving the response message to the connection request and/or the service confirm message, the sender forms a GO and connects a file transfer service session to the receiver in step 815, and transmits the file to the receiver through the file transfer service session in step 817. Before step 815, the sender may receive the wait message in FIGS. 2 and 3, and the join message in FIG. 4, and the wait message or the join message may include status information used to indicate whether the receiver 272 can use other services. In other words, connection capability of the receiver 272 is reflected in the status information. For example, if the receiver 272 can use other services, the status information is set to “Available”. On the other hand, if the receiver 272 cannot use other services, the status information is set to “Unavailable”.

In an alternative embodiment, upon receiving the response message to the connection request and/or the service confirm message in step 813, the sender may restore receiver's connection capability information, and derive topology based on its own capability and received capability. In another alternative embodiment, upon receiving the response message to the connection request and/or the service confirm message in step 813, the sender may start a new group, join a receiver's group, or a sender's group.

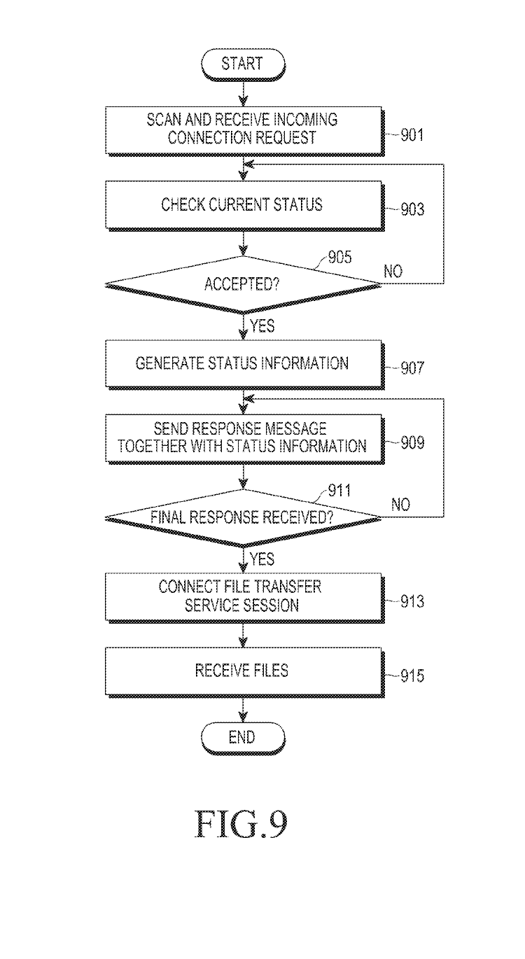

FIG. 9 is a flowchart illustrating a topology handling method by a receiver in a wireless communication system according to an embodiment of the present invention.

In step 901, a receiver performs scanning and receives a provision discovery request message (or incoming connection request message). Upon receiving the provision discovery request message (or incoming connection request message), the receiver notifies the sender that the incoming connection request message is received at the user of the receiver, and requests the user to check the current status, in step 903. In step 905, the receiver determines whether the request is accepted by the user. Step 905 is step in which the receiver determines whether the user will use other services. If the request is not accepted by the user, the receiver waits until the request is accepted, and the process returns to step 903. However, if the request is accepted by the user, the receiver generates the above-described status information in step 907, and sends a response message to the discovery request message (or incoming connection request message) to the sender together with the status information in step 909. Thereafter, in step 911, the receiver determines whether it has received a final response message from the sender. Upon receiving the final response message from the sender, the receiver forms a group and connects a file transfer service session in step 913, and receives a file through the file transfer service session in step 915.

However, upon failure to receive the final response message from the sender, the receiver repeats step 909 and its succeeding steps until it receives the final response message.

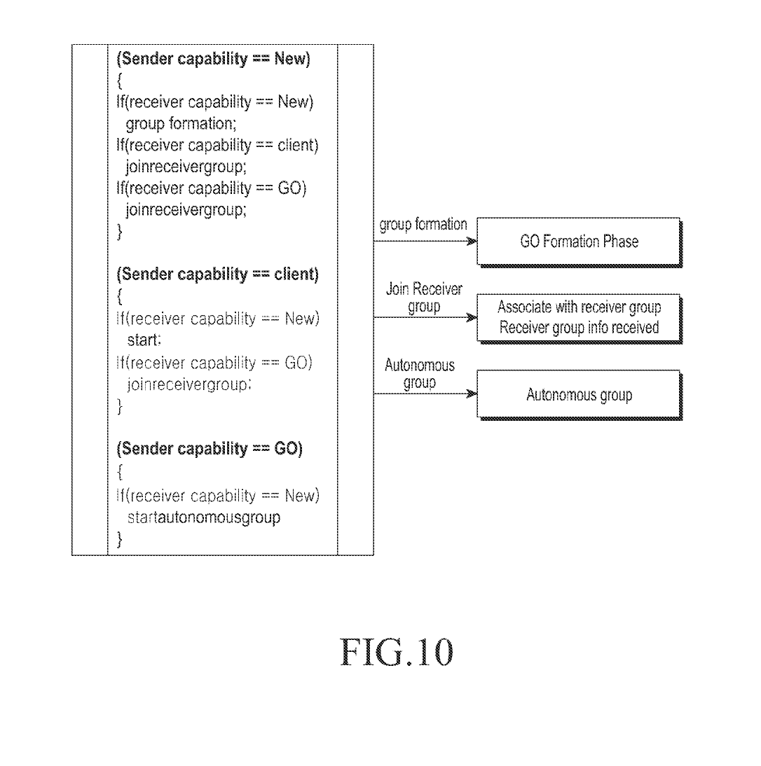

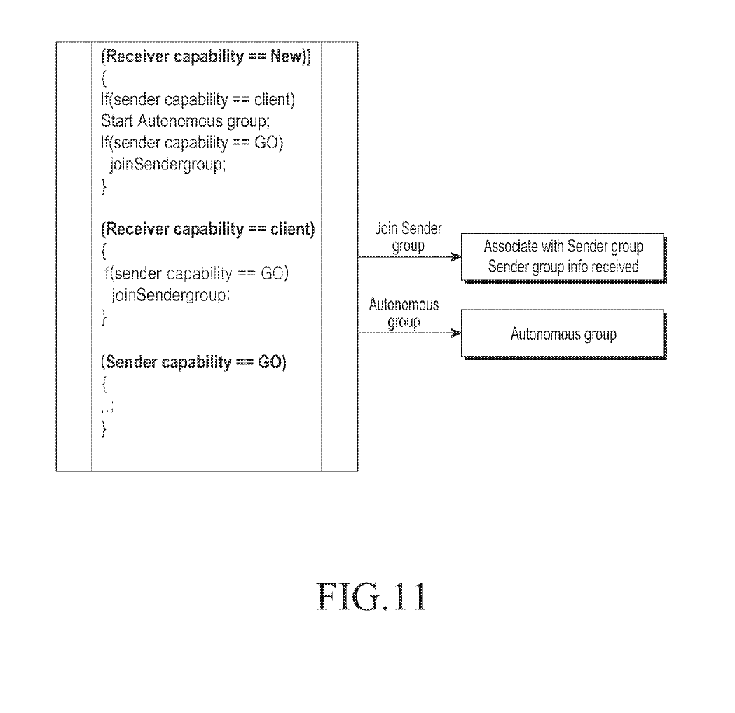

FIGS. 10 and 11 are topology flow diagrams for a sender and a receiver according to an embodiment of the present invention.

Referring to FIG. 10, if Sender capability is “New” and Receiver capability is “New”, the sender will perform GO negotiation with the receiver.

If Sender capability is “New” and Receiver capability is “Client”, the sender will join a group of the receiver.

If Sender capability is “New” and Receiver capability is “GO”, the sender will join a group of the receiver.

If Sender capability is “Client” and Receiver capability is “New”, the sender will autonomously start a P2P group by becoming a P2P GO.

If Sender capability is “Client” and Receiver capability is “GO”, the sender will join a group of the receiver.

If Sender capability is “GO” and Receiver capability is “New”, the receiver will autonomously join a group of the sender.

Referring to FIG. 11, if Receiver capability is “New” and Sender capability is “Client”, the receiver will autonomously join a group.

If Receiver capability is “New” and Sender capability is “GO”, the receiver will join a group of the sender.

If Receiver capability is “Client” and Sender capability is “GO”, the receiver will join a group of the sender.

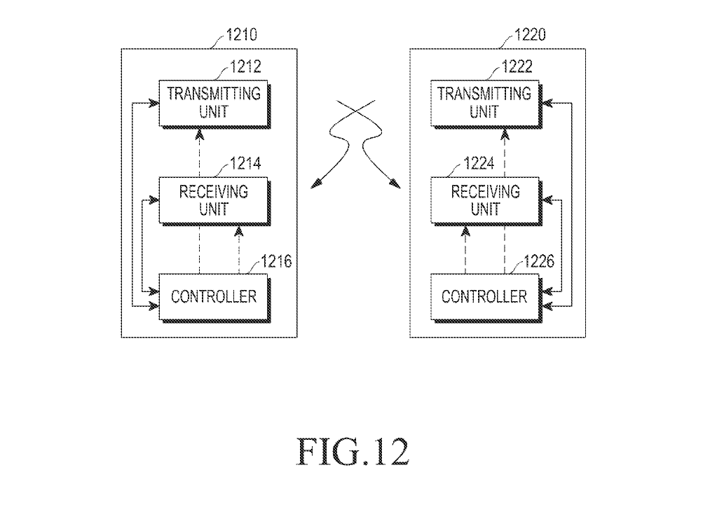

FIG. 12 is a block diagram illustrating structures of a sender and a receiver according to an embodiment of the present invention. Referring to FIG. 12, a sender 1210 sends its desired transmission file to a receiver 1220 using a Wi-Fi Direct function with the receiver.

A receiving unit 1214 of the sender 1210 receives from the receiver 1220 confirm information and/or status information indicating whether a user of the receiver 1220 accepts or rejects its file transfer.

Based on the confirm information and/or status information received from the receiver 1220, a controller 1216 of the sender 1210 determines whether to continue or interrupt its Wi-Fi Direct connection to the receiver 1220.

A receiving unit 1224 of the receiver 1220 receives from the sender 1210 a file that the sender 1210 desires to send. A transmitting unit 1222 of the receiver 1220, under control of a controller 1226, transmits to the sender 1210 the confirm information indicating whether the user of the receiver 1220 will accept or reject the file transfer. Based on an invite message received from the sender 1210, the controller 1226 of the receiver 1220 inquires of the user whether he/she will accept the file transfer service from the sender 1210, generates confirm information and/or status information based on the inquiry results, and provides the generated information to the transmitting unit 1222 of the receiver 1220.

Based on the confirm information and/or status information, the controller 1226 of the receiver 1220 may determine whether to continue or interrupt its Wi-Fi Direct connection to the sender 1210.

It is understood that the topology handling method according to embodiments of the present invention may be implemented by hardware, software or a combination thereof. The software may be stored in a volatile or non-volatile storage (for example, erasable/rewritable Read Only Memory (ROM)), a memory (for example, Random Access Memory (RAM), a memory chip, and an Integrated Circuit (IC) chip), or an optically or magnetically recordable machine (for example, computer)-readable storage medium (for example, Compact Disc (CD), Digital Versatile Disc (DVD), magnetic disc, and magnetic tape). The topology handling method may be implemented by a computer or a mobile terminal including a controller and a memory. The memory may be a machine-readable storage medium suitable to store a program(s) including instructions for implementing embodiments of the present invention.

Therefore, the present invention may include a program including codes for implementing the apparatus and method as set forth in the appended claims, and a machine (for example, computer)-readable storage medium storing the program. This program may be electronically transferred through any medium such as communication signals which are transmitted through wire/wireless connections, and the present invention may include their equivalents.

As is apparent from the foregoing description, the topology handling method and apparatus may reduce errors when periodically transmitting files to a discovered counterpart terminal in a wireless communication system.

The topology handling method and apparatus may efficiently form a P2P group with another device that has already formed a group, in a wireless communication system.

The topology handling method and apparatus may reduce signaling overhead for device connection between two peer devices desiring to form a new group when one of the peer devices has joined the existing group.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A topology handling method for supporting a first device to form a Peer to Peer (P2P) group with a second device in a wireless communication system, the method comprising:
sending, by the first device, an invitation request to the second device; and
upon receiving a wait message from the second device in response to the invitation request, performing a negotiation procedure for forming the P2P group with the second device, based on status information included in the wait message;
wherein the status information is used to indicate whether the second device can use other services.

2. The topology handling method of claim 1, wherein if the status information is “Available”, the status information indicates that the second device can use other services.

3. The topology handling method of claim 1, wherein if the status information is “Unavailable”, the status information indicates that the second device cannot use other services.

4. The topology handling method of claim 1, wherein the second device is a device that has joined another P2P group.

5. The topology handling method of claim 4, wherein the second device is one of a Group Owner (GO) and a client of another P2P group.

6. The topology handling method of claim 1, wherein the negotiation procedure includes GO negotiation.

7. A topology handling method for supporting a first device to form a Peer to Peer (P2P) group with at least one second device in a wireless communication system, the method comprising:
sending, by the first device, an open service request to all devices; and
upon receiving a response message to the open service request from at least one second device among all the devices, performing a negotiation procedure for forming the P2P group with the at least one second device based on status information included in the response message;
wherein the status information is used to indicate whether the at least one second device can use other services.

8. The topology handling method of claim 7, wherein if the status information is “Available”, the status information indicates that the second device can use other services.

9. The topology handling method of claim 7, wherein if the status information is “Unavailable”, the status information indicates that the second device cannot use other services.

10. The topology handling method of claim 7, wherein the at least one second device is a device that has joined another P2P group.

11. The topology handling method of claim 10, wherein the at least one second device is one of a Group Owner (GO) and a client of another P2P group.

12. The topology handling method of claim 7, wherein the negotiation procedure includes GO negotiation.

13. A topology handling apparatus for supporting a first device to form a Peer to Peer (P2P) group with a second device in a wireless communication system, the apparatus comprising:
a transmitting unit of the first device, which is configured to send an invitation request to the second device; and
a controller of the first device, which is configured to, upon receiving a wait message from the second device in response to the invitation request, perform a negotiation procedure for forming the P2P group with the second device, based on status information included in the wait message;
wherein the status information is used to indicate whether the second device can use other services.

14. A topology handling apparatus for supporting a first device to form a Peer to Peer (P2P) group with at least one second device in a wireless communication system, the apparatus comprising:
a transmitting unit of the first device, which is configured to send an open service request to all devices; and
a controller of the first device, which is configured to, upon receiving a response message to the open service request from at least one second device among all the devices, perform a negotiation procedure for forming the P2P group with the at least one second device based on status information included in the response message;
wherein the status information is used to indicate whether the at least one second device can use other services.

15. A topology handling method for supporting a second device to form a Peer to Peer (P2P) group with a first device in a wireless communication system, the method comprising:
receiving, by the second device, an invitation request from the first device;
sending, to the first device, a wait message including status information indicating whether the second device can use other services; and
performing a negotiation procedure for forming the P2P group with the first device, based on the status information.

16. A topology handling method for supporting at least one second device to form a Peer to Peer (P2P) group with a first device in a wireless communication system, the method comprising:
receiving, by the at least one second device, an open service request from the first device;
sending to the first device a response message including status information indicating whether the at least one second device can use other services; and
performing a negotiation procedure for forming the P2P group with the first device.

17. A topology handling apparatus for supporting a second device to form a Peer to Peer (P2P) group with a first device in a wireless communication system, the apparatus comprising:
a receiving unit of the second device, which is configured to receive an invitation request from the first device;
a transmitting unit of the second device, which is configured to send, to the first device, a wait message including status information indicating whether the second device can use other services; and
a controller of the second device, which is configured to perform a negotiation procedure for forming the P2P group with the first device, based on the status information.

18. A topology handling apparatus for supporting at least one second device to form a Peer to Peer (P2P) group with a first device in a wireless communication system, the apparatus comprising:
a receiving unit of the at least one second device, which is configured to receive an open service request from the first device;
a transmitting unit of the at least one second device, which is configured to send to the first device a response message including status information indicating whether the at least one second device can use other services; and
a controller of the at least one second device, which is configured to perform a negotiation procedure for forming the P2P group with the first device.
